(19) United States
(12) Patent Application Publication
(10) Pub. No.: US 2015/0181536 A1
(43) Pub. Date: Jun. 25, 2015

(54) Power Control in Wireless Communications

(71) Applicants: Klaus Ingemann Pedersen, Aalborg (DK); Stanislaw Strzyz, Poznan (PL); Beatriz Soret, Aalborg (DK)

(72) Inventors: Klaus Ingemann Pedersen, Aalborg (DK); Stanislaw Strzyz, Poznan (PL); Beatriz Soret, Aalborg (DK)

(21) Appl. No.: 14/385,563

(22) PCT Filed: Mar. 16, 2012
(86) PCT No.: PCT/EP2012/054634

§ 371 Date: Jan. 19, 2015

(51) Int. Cl. H04W 52/24; H04W 72/04

(52) U.S. Cl. CPC H04W 52/243; H04W 72/0473

(57) ABSTRACT

In accordance with a method for power control in wireless communications, including a first radio node determines that a different muted subframe transmission power is desired. A request to a second radio node for a different muted subframe transmission power is then signalled. The request is taken into account by the second radio node in setting transmission power of at least one muted subframe.

The application relates to wireless communications and more particularly to downlink power control in a wireless communication system where muting of subframes is enabled.

A communication system can be seen as a facility that enables communication sessions between two or more nodes such as fixed or mobile communication devices, access points such as base stations, servers and so on. A communication system and compatible communicating devices typically operate in accordance with a given standard or specification which sets out what the various entities associated with the system are permitted to do and how that should be achieved. For example, the standards, specifications and related protocols can define the manner how and what communication devices shall communicate with the access points, how various aspects of the communications shall be implemented and how the devices shall be configured.

Signals can be carried on wired or wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells. Different types of cells can provide different features. For example, cells can have different shapes, sizes, power levels and other characteristics.

A user can access the communication system by means of an appropriate communication device. A communication device of a user is often referred to as user equipment (UE) or terminal. A communication device is provided with an appropriate signal receiving and transmitting arrangement for enabling communications with other parties. Wireless systems enable mobility for users where a mobile device can communicate over an air interface with another communication device such as e.g. a base station and/or other user equipment.

Examples of mobile communication systems are those based on standards by the 3rd Generation Partnership Project (3GPP). A 3GPP development is often referred to as the long-term evolution (LTE) of the Universal Mobile Telecommunications System (UMTS) radio-access technology. The various development stages of the 3GPP LTE specifications are referred to as releases. In LTE base stations are commonly referred to as enhanced NodeBs (eNB). In LTE a node providing a relatively wide coverage area is referred to as a macro eNode B. Network nodes can also provide smaller service areas. Examples of such smaller or local radio service area network nodes include femto nodes such as Home eNBs (HeNB), pico nodes such as pico eNodeBs (pico-eNB), micro nodes and remote radio heads. A smaller radio service area can be located wholly or partially within one or more larger radio service areas. In some instances a combination of wide area network nodes and small area network nodes can be deployed using the same frequency carriers (e.g. co-channel deployment). Coordinated multipoint (CoMP) transmissions have also been proposed. Different radio technologies may be used at the same time in a multi-layered system. Multi-layered systems are often referred to as heterogeneous networks or HetNets. An example of a multi-layered system is a mixture of macro base stations and small power base stations (e.g. pico and micro stations). The various layers can be deployed as part of a cellular network. It is noted that a multi-layer LTE network is used herein only as an example and that other solutions are also possible.

Interference caused by the different stations affects wireless system performance. A way to address interference is to transmit at least some of the transmission elements with reduced or minimal energy so that reduced power and/or other interfering activity is caused by the transmission thereof. An example of such transmission elements are subframes that are muted. An example of muted subframes is an almost blank subframe (ABS). Almost blank subframes are subframes that are transmitted with reduced transmit power, or subframes with no transmission power, and/or reduced activity on at least one physical channel. Interference coordination where interference between different radio service areas is coordinated may also be provided. A so-called muting pattern may be used for the coordination. A muting pattern can be used in association with different nodes in a network, for example to enforce muting in nodes such as macro, pico and femto nodes. The muting patterns are typically configured to provide time periods where one or more cells will not transmit, or the transmissions are kept in their minimum so as to ensure interference free periods for the transmissions in another cell or cells.

A detailed example is an aspect of the recent LTE releases providing enhanced inter-cell interference coordination (eICIC) and a further enhanced inter-cell interference coordination (FeICIC) that can be applied to network nodes to reduce interference. eICIC was introduced in LTE Release 10 while FeICIC is a part of LTE Release 11. In certain inter-eNB signaling FeICIC is provided for co-channel macro and pico cell deployments. The FeICIC can be operated with a feature referred to as low power (LP) almost blank subframes (ABS). In a typical almost blank subframe only (ABS) Common Reference Symbol (CRS) or Channel State Information (CSI) Reference Symbol (RS) is transmitted whilst the physical downlink shared channel (PDSCH) can be muted.

LTE Release 10 assumed that an eNB transmitting ABS did not schedule any users. However, in accordance with Release 11 an eNB capable of scheduling users in LP-ABS with a reduced transmission power. LP-ABS is assumed to have data transmission with a lower transmission power as compared to the transmission power in normal subframes. In a low power ABS subframe the data channel (PDSCH) is transmitted with reduced power whereas in a Release 10 ABS the PDSCH is not transmitted at all. Thus the average transmit powers per subframe can be ordered such that a normal subframe has the highest transmit power, low power ABS has a “medium” transmit power, and Release 10 ABS can have the lowest transmit power.

The inventors have recognized that a low power ABS configuration by a macro cell may not reflect the actual needs of a pico cell or pico cells and/or may not be provided in response of the actual interference affecting user equipment in a cell.

It is noted that the above discussed issues are not limited to any particular communication environment and station apparatus but may occur in any appropriate system where cells are selected by mobile devices.

Embodiments of the invention aim to address one or several of the above issues.

In accordance with an embodiment there is provided a method for power control in wireless communications, comprising determining in a first radio node that a different muted subframe transmission power is desired, and sending a request to a second radio node for a different muted subframe transmission power.

In accordance with another embodiment there is provided a method for power control in wireless communications, comprising receiving from at least one first radio node a request for a different muted subframe transmission power by a second radio node, and taking the request for different muted subframe transmission power into account in setting transmission power of at least one muted subframe by the second radio node.

In accordance with another embodiment there is provided an apparatus for power control in a radio node, the apparatus comprising at least one processor, and at least one memory including computer program code, wherein the at least one memory and the computer program code are configured, with the at least one processor, to determine that a different muted subframe transmission power is desired, and cause sending of a request for a different muted subframe transmission power.

In accordance with a yet another embodiment there is provided an apparatus for power control in a radio node, the apparatus comprising at least one processor, and at least one memory including computer program code, wherein the at least one memory and the computer program code are configured, with the at least one processor, to receive from at least one other radio node a request for a different muted subframe transmission power, and take the request for different muted subframe transmission power into account in setting transmission power of at least one muted subframe.

In accordance with a more specific aspect the different transmission power comprises a lowered transmission power.

The muted subframe may comprise an almost blank subframe or a low power almost blank subframe.

The request may comprise a requested change expressed in an absolute or relative value. The relative value may comprise an increase or decrease of transmission power relative to the current transmission power of muted subframes.

The different transmission power may be set based on information of channel quality in at least one cell.

The request may be signalled by means of X2 protocol. The request may be signalled as a part of load information and/or resource status information exchange.

A network element such as a base station and/or control apparatus thereof can be configured to operate in accordance with the various embodiments. The element may comprise a pico or macro node and/or an enhanced Node B.

It should be appreciated that any feature of any aspect may be combined with any other feature of any other aspect.

Embodiments will now be described in further detail, by way of example only, with reference to the following examples and accompanying drawings, in which:

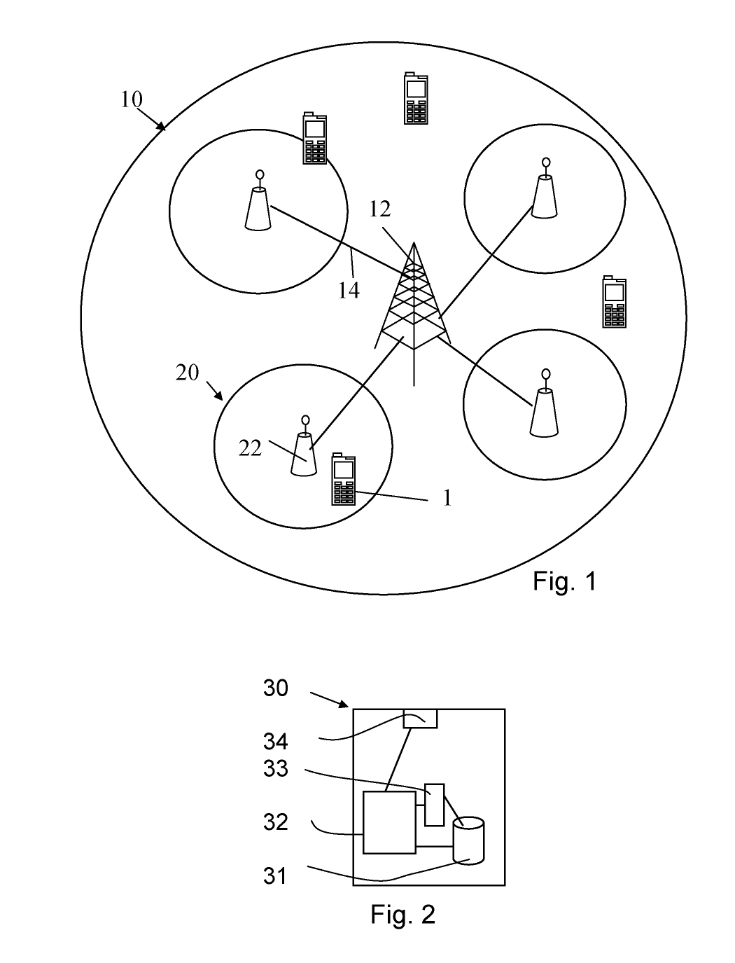

FIG. 1 shows a schematic diagram of a communication system according to some embodiments;

FIG. 2 shows a schematic diagram of a control apparatus according to some embodiments;

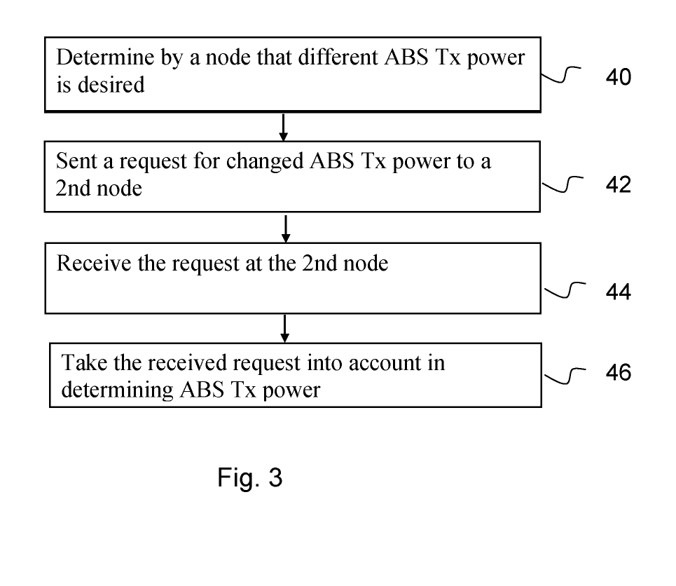

FIG. 3 shows a flowchart according to an embodiment; and

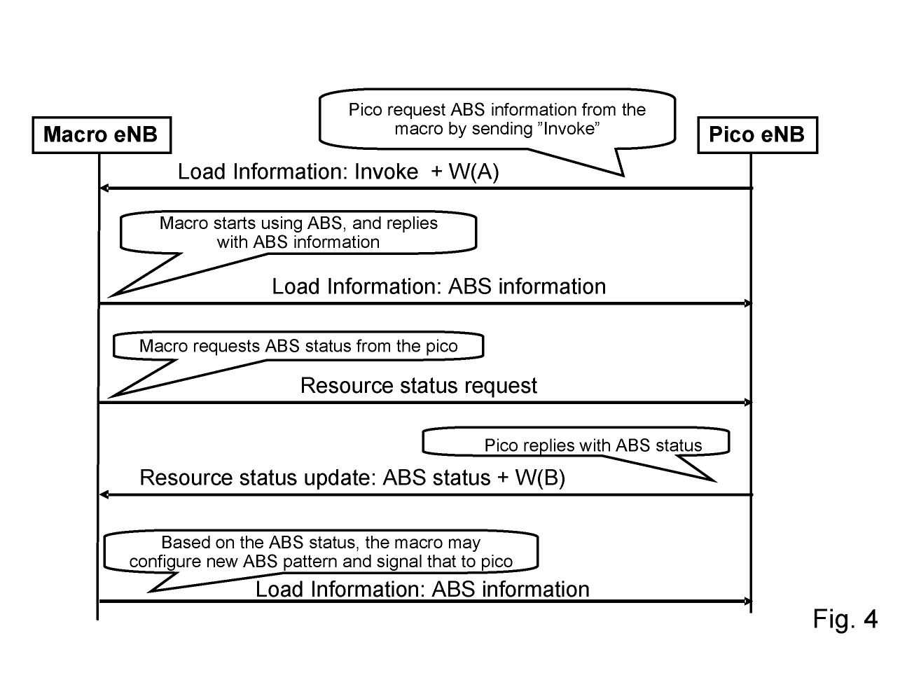

FIG. 4 shows signalling flow in accordance with a protocol and use thereof according to two different examples.

In the following certain exemplifying embodiments are explained with reference to a wireless or mobile communication system serving mobile communication devices. Before explaining in detail the exemplifying embodiments, certain general principles of wireless communications are briefly explained with reference to FIGS. 1 and 2 to assist in understanding the technology underlying the described examples.

A non-limiting example of the recent developments in communication system architectures is the long-term evolution (LTE) of the Universal Mobile Telecommunications System (UMTS) standardized by the 3rd Generation Partnership Project (3GPP). More recent development of the LTE, Release 10 and upwards, are sometimes referred to as LTE-Advanced. The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

Mobile communication devices 1 can be provided with wireless access via base stations or similar wireless transmitter and/or receiver nodes providing radio service areas or cells. The base stations are typically connected to a wider communications network via appropriate gateways. In FIG. 1 five radio service areas 10 and 20 are shown as being provided by base stations 10 and 20. It is noted that the number of cells and the cell borders are only schematically shown for illustration purposes in FIG. 1, and that these can vary considerably from that shown. It shall be understood that the sizes and shapes of the cells may vary considerably from those shown in FIG. 1. Different types of possible cells include those known as macro cells, pico cells, micro cells and femto cells. For example, in LTE-Advanced the transmission/reception points or base stations can comprise wide area network nodes 12 such as a macro eNode B (eNB) which may, for example, provide coverage for an entire macro cell 10 or similar radio service area. Base station can also be provided by small or local radio service area network nodes, for example Home eNBs (HeNB), pico eNodeBs (pico-eNB), or femto nodes 20. Some applications utilise radio remote heads (RRH) that are connected to for example an eNB. A mobile communication device 1 may be located in the service area of different cell, communicate with more than one cell and be handed over from a cell to another. In particular, FIG. 1 depicts a macro cell 10 provided by wide area base station 12 and four smaller cells 20 provided by local base stations 22. in this example can be a pico-cell or a femto cell. Base station nodes may communicate via each other via fixed line connection and/or air interface. The logical connection 14 between the base station nodes can be provided for example by an X2 interface.

Base stations are typically controlled by at least one appropriate controller apparatus so as to enable operation thereof and management of mobile communication devices in communication with the base stations. The control apparatus can be interconnected with other control entities. FIG. 2 shows an example of a control apparatus capable of operating in accordance with the embodiments, for example to be coupled to and/or for controlling a base station. The control apparatus 30 can be arranged to provide control on communications in the service area of a cell. In some embodiments a base station can comprise a separate control apparatus. In other embodiments the control apparatus can be another network element. The control apparatus 30 can be configured to provide control functions in association with generation and communication of information of cells and/or control functions based on such information by means of the data processing facility in accordance with certain embodiments described below. For this purpose the control apparatus comprises at least one memory 31, at least one data processing unit 32, 33 and an input/output interface 34. The control apparatus can be coupled to a receiver and/or transmitter of the base station via the interface. The control apparatus can be configured to execute an appropriate software code to provide the control functions. The control apparatus and functions may be distributed between a plurality of control units. In some embodiments, each base station can comprise a control apparatus. In alternative embodiments, two or more base stations may share a control apparatus.

A possible mobile device 1 for communications with the base stations will now be briefly described. Such a device is often referred to as user equipment (UE) or terminal. An appropriate mobile device may be provided by any device capable of sending radio signals to and/or receiving radio signals from multiple cells. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile device may provide, for example, communication of data for carrying communications such as voice, electronic mail (email), text message, multimedia and so on. Users may thus be offered and provided numerous services via their devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information. The mobile device may receive and transmit signals over an air interface with multiple base stations via an appropriate transceiver apparatus.

A wireless communication device, such as a base station and/or a mobile station, can be provided with a Multiple Input/Multiple Output (MIMO) antenna system for enabling multi-flow communications. MIMO arrangements as such are known. MIMO systems use multiple antennas at the transmitter and receiver along with advanced digital signal processing to improve link quality and capacity. More data can be received and/or sent where there are more antenna elements.

In accordance with an embodiment shown by the flowchart of FIG. 3 for power control in wireless communications it is first determined at 40 in a first radio node that a different transmission power of at least one muted subframe is desired. This determination can be based on local conditions in the cell of the node, for example at least in part based on quality reports from the mobile devices served by the cell. A request can then be sent at 42 to a second radio node for a different transmission power to be used for muted subframes. The first node may be a local or a smaller coverage node and the second node can be a controlling/master node, for example a macro node.

The second node receives the request for different transmission power at 44. The request for different transmission power can be taken, at least in part, into account in setting the transmission power of muted subframes such as low power almost blank subframes at 46. The second node may receive request from a plurality of smaller nodes, and optimise the power control based on more than one request as well as other information.

The following example is given in relation to further enhanced inter-cell interference coordination (FeICIC) in certain inter-eNB signaling scenarios, more particularly where FeICIC is provided for a co-channel macro and pico cell deployment. For a macro and pico co-channel scenario, certain basic characteristics of FeICIC can be assumed. The macro and pico are time-synchronized on subframe resolution. The pico eNBs are scheduling users in all subframes with the same transmission power. The macro eNBs transmit ABS or LP-ABS in a subset of the subframes. The transmission power is lower for ABS/LP-ABS as compared to normal subframes. During subframes with ABS, or LP-ABS, there is less interference generated to the pico connected users. Hence, during these subframes, the pico eNB can schedule users that would otherwise experience high interference from the macro-layer (e.g. users subject to high pico range extension).

To exploit the full benefit of FeICIC the percentage of ABS, or LP-ABS, at the macro layer shall be carefully configured. The transmit power reduction, denoted herein as W dB, of the LP-ABS should also be carefully adjusted. Ideally, the configuration of these FeICIC parameters can be adjusted according to the local interference and load conditions at the macro and pico eNB with the aim to yield an optimal, preferably the best possible, overall system performance.

In accordance with an embodiment a mechanism is provided to facilitate coordinated setting of the LP-ABS power control, for example power reduction. In distributed dynamic configuration of ABS muting patterns a macro eNB is assumed to act as a master node, and is therefore the eNB which decides which subframes to configure as ABS. The macro eNB can have various sources of information available for deciding whether one or more subframes shall be ABS. Among other matters, the macro eNBs can estimate if it can configure more subframes as ABS while still being able to serve all of its users, or at least an acceptable level of its users, according to their minimum quality of service (QoS) requirements. For example, the X2 application protocol (AP) facilitates collaborative configuration of ABS muting patterns between eNBs.

In accordance with an embodiment additional exchange of inter-eNB information is provided to have coordinated setting of a power reduction of LP-ABS. This can be provided, for example, in environment such as the macro/pico eNBs of FIG. 1. Signalling between macro and pico eNBs can be provided such that the pico eNB can request regulation of transmitted power in almost blank subframes. The request can be interpreted at the macro eNB as a non-binding request that can be taken into account in ABS transmission power control.

X2 protocol based signaling can be used to facilitate the coordinated adjustment of power reduction for low power almost blank subframes (ABS) in case further enhanced inter-cell interference coordination (FeICIC) is used. As mentioned previously, FeICIC aims to reduce the interference from macro to pico connected UEs by using either ABS, or LP-ABS at the macro eNBs. Thus, the pico eNBs are considered to have the required information to best estimate the desired power lever of LP-ABS applied at the macro eNBs. This can be based on information of parameters such as channel quality in the cell. For example, a pico eNB can be made aware of the channel quality of its users via channel quality indicator (CQI) feedback, and hence can use this as a priori information for further guiding the macro-eNBs on how to set the value of change in the power for LP-ABS.

An eNB can be configured to send a message to another eNB to propose a setting of a desired power reduction for LP-ABS. For example, a pico eNB 22 of FIG. 1 can send a message proposing a value of power control parameter to the macro eNB 12. The proposed value can be signalled as an absolute value, for example as a parameter W defining the actual transmission power. According to a possibility a relative value, for example a delta value is sent. The “delta value” refers to signalling a proposal for the receiving eNB to either increase or decrease the current used value of W by a defined amount of decibels.

The following describes mechanisms for facilitating the macro eNBs to configure parameter W when LP-ABS is used with reference to FIG. 4. The figure shows an example for X2 signalling for coordinated adaptation of ABS muting pattern. In accordance with a non-limiting example the inter-eNB signalling of proposed W parameter setting (absolute or delta value) is included in the load information message from a pico eNB. In this approach sending of the Invoke message could be supplemented with suggested value for W. Thus, the pico eNB can send a Load Information X2 message to a macro eNB containing, in addition to an information element (IE) Invoke, a request for different transmission power. This example of the proposed desired power value is denoted as W(A) in FIG. 4. The Invoke message indicates to the macro eNB that the pico eNB would like to receive ABS information from the macro, potentially with more subframes configured with ABS. The macro eNB can respond to this message by sending another X2 Load Information message to the pico with IE ABS information. The ABS information can include information of the currently used ABS muting pattern at the macro-eNB.

Furthermore, the macro-eNB can initialise a Resource status reporting initialisation procedure, thereby asking the pico to report usage of the allocated ABS resource. The pico can provide the information with a Resource status update message with IE ABS status. The ABS status provides the macro eNB with useful information on how much of the ABS resource is blocked at the pico node; either because of scheduling of critical UEs during subframes where macro uses ABS, or because of other limitations. In this context, the term “critical UEs” refers to UEs that are only schedulable by the pico during subframes where the macro uses ABS. In the ABS Status, the pico may also indicate that part of the allocated ABS resource is not usable, e.g. due to interference experienced from other macro-eNBs. Thus, based on the ABS status, the macro eNB is provided with additional information to determine the consequences of configuring more or less subframes as ABS, before potentially deciding on a new ABS muting pattern. Whenever the macro eNB decides to change the ABS muting pattern it informs the pico eNBs in its coverage area by sending the ABS information.

An option is to include inter-eNB signalling of information of the desired change in transmission (Tx) power in the Resource status procedure. In this option an eNB is configured to send a Resource status request to another eNB, and that eNB then responds with a Resource status update message with a suggested value of power, this option being denoted as W(B).

The signalling of W (absolute or relative) from pico to macro can only be regarded as a proposal. The macro node is free to decide which value of W to use. In addition to the proposed value of W from one or more smaller cells, the macro node may also use other information to decide on the used value of W. Examples of such information include other load measures and so on.

The above described embodiments may provide several advantages. In particular, the actual interference situation in a cell can be taken better into account, and/or responded in a fast manner. For example, power control by a macro node, for example the amount of power reduction may better correspond to the actual need of the pico. Also, a lower level cell is provided with capability to negotiate the transmitted power in view of the actual scheduling power needs of mobile stations in interference situations.

It is noted that whilst embodiments have been described using LTE and LTE Advanced as examples, similar principles can be applied to any other communication system or indeed to further developments with LTE. Thus, instead of LTE, the invention may be applied to other cellular standards as well. Different layers may be implemented in different radio access technology (RAT), for example such that a GSM macro layer and LTE micro layer is provided. Also, instead of carriers provided by base stations at least one of the carriers may be provided by a communication device such as mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1-25. (canceled)

26. A method for power control in wireless communications, comprising:
determining in a first radio node that a different muted subframe transmission power is desired, and
sending a request to a second radio node for a different muted subframe transmission power.

27. A method for power control in wireless communications, comprising:
receiving from at least one first radio node a request for a different muted subframe transmission power by a second radio node, and
taking the request for different muted subframe transmission power into account in setting transmission power of at least one muted subframe by the second radio node.

28. A method according to claim 26, wherein the muted subframe comprises an almost blank subframe or a low power almost blank subframe.

29. A method according to claim 27, comprising signalling the request by means of X2 protocol.

30. A method according to claim 29, comprising signalling the request as a part of load information and/or resource status information exchange.

31. A method according to claim 26, wherein the first radio node comprises a pico node and the second radio node comprises a macro node.

32. A method according to claim 26, wherein at least one of the radio nodes comprises an enhanced Node B.

33. An apparatus for power control in a radio node, the apparatus comprising at least one processor, and at least one memory including computer program code, wherein the at least one memory and the computer program code are configured, with the at least one processor, to
determine that a different muted subframe transmission power is desired, and
cause sending of a request for a different muted subframe transmission power.

34. An apparatus for power control in a radio node, the apparatus comprising at least one processor, and at least one memory including computer program code, wherein the at least one memory and the computer program code are configured, with the at least one processor, to
receive from at least one other radio node a request for a different muted subframe transmission power, and
take the request for different muted subframe transmission power into account in setting transmission power of at least one muted subframe.

35. An apparatus according to claim 34, wherein the muted subframe comprises an almost blank subframe or a low power almost blank subframe.

36. An apparatus according to claim 33, configured to cause signalling of the request by means of X2 protocol.

37. An apparatus according to claim 33, configured to cause signalling of the request as a part of load information and/or resource status information exchange.

38. A network device comprising an apparatus as defined in claim 33.

39. A pico or macro node comprising an apparatus according to claim 38.

40. An enhanced Node B comprising the apparatus according to claim 33.

41. A communication system comprising the apparatus of claim 33.

42. A computer program comprising code means adapted to perform the steps of claim 26 when the program is run on a processor.
